(19) United States
(12) Patent Application Publication
(10) Pub. No.: US 2005/0186530 A1
(43) Pub. Date: Aug. 25, 2005

(54) Hollow needle for obturating dental cavities

(76) Inventor: Aldo Eagle, Corona Del Mar, CA (US)

Correspondence Address: Alfred E. Miller, 406 West Putnam Avenue, Greenwich, CT, 06830, US

(21) Appl. No.: 10/785,368

(22) Filed: Feb. 25, 2004

(51) Int. Cl. A61C 5/04

(52) U.S. Cl. 433/89

(57) ABSTRACT

A two-part needle for a dental syringe in which the first part of the needle is attached to the syringe and has a larger cross0section than the other part, which is malleable, can be increased while the first part has a chamber for housing a cartridge with thermoplastic material therein that is caused to flow through the needle and into the dental cavity.

The present invention is directed to a hollow needle in which the heated open-ended cartridge containing thermoplastic material, such as gutta-percha, is housed within a part of the needle and ejected into the dental cavity, for example, in a root canal procedure.

The ejection device is normally an endodontic syringe having a means for forcing the gutta-percha, or other thermoplastic material from the cartridge and through the hollow needle to the root canal. The thermoplastic material is initially heated in the syringe by heating means therein. The ejection means can be a piston, which is driven into the cartridge material so the heated thermoplastic material is caused to flow-through the needle and into the dental cavity conforming to the configuration of the cavity, resulting in the obturation of the cavity. The ejection means may be manual or motor-driven.

In the past, the heated thermoplastic material was contained in a cartridge housed in the syringe as particularly shown and described in U.S. Pat. No. 4,684,344 to Brockway et al. in which the thermoplastic material is heated and ejected into a needle by a plunger. In dentistry it is known to obdurate cavities, such as in root canal procedures, by forcing heated thermoplastic material, which is usually gutta-percha into the dental cavity by means of syringe having a cartridge of the material therein and a plunger to extrude the material into the site of the cavity. Such an arrangement is also shown in U.S. Pat. No. 4,357,136 to Herskovitz et al. The hollow needle is shown attached to a syringe. A drawback to this type of arrangement is that after the plunger ejects the thermoplastic material from the syringe some material, such as gutta-percha, remains in the syringe and must be thoroughly cleaned out of the chamber before the syringe is used again.

### SUMMARY OF THE INVENTION

In view of the foregoing, it is a feature of the present invention to eliminate the difficult procedure of cleaning a syringe housing a thermoplastic material that was formerly heated to a plastic state that has cooled down and adheres to the walls of the syringe. It is burdensome to remove this material from the chamber of the syringe. Accordingly, it is an object of the present invention to provide a cartridge of thermoplastic material, for example, for a root canal procedure, within the hollow needle itself forming a closed system entirely within the disposable needle, thus maintaining the syringe in clean condition for repeated use.

Another object of the present invention is to provide a two-part needle in which the rear section houses the cartridge provided with thermoplastic material while the forward section, which is attached to the rear section, is reduced in diameter. The forward section can be between 20 mm and 30 mm long, depending upon the requirements of the dental professional. Thus, the working length of the needle can be changed, if required.

It is a further object of the present invention to provide a needle of high thermal conductivity in the form of alloy such as cusid, or a thermo conductive plastic.

The above and other features and objects of the present invention will be apparent by reference to the following description of the invention together with the drawings.

### BRIEF DESCRIPTION OF THE DRAWINGS

In order that the invention may be more clearly understood it will now be disclosed in greater detail with reference to the accompanying drawings, in which:

FIG. 1 is a perspective view of the hollow needle having a rear section for accommodating a cartridge having thermoplastic material therein and a forward section of reduced diameter attached to the rear section, all in accordance with the teachings of the invention.

FIG. 2 is a sectional view taken along the lines 2-2 of FIG. 1 showing the attachment of the forward section to the rear section of the needle.

FIG. 3 is a sectional view similar to FIG. 2 showing the cartridge in place in the needle with the plunger pushing the thermoplastic material through the needle, and

FIG. 4 is a side elevational view of the open-ended cartridge.

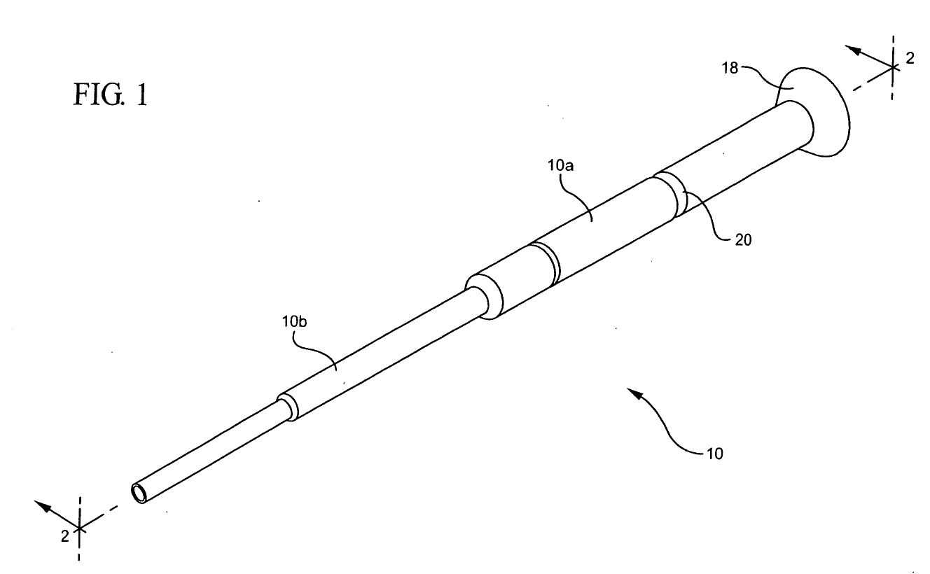

### DESCRIPTION OF THE PREFERRED EMBODIMENT

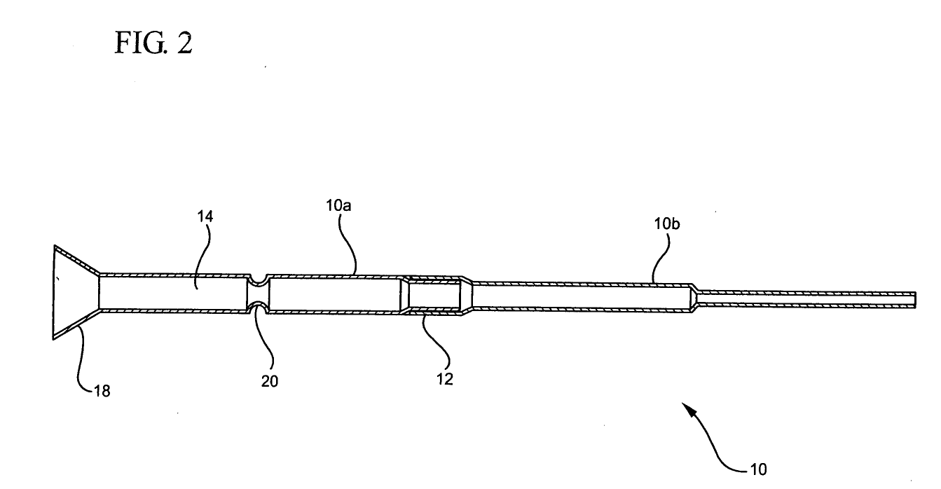

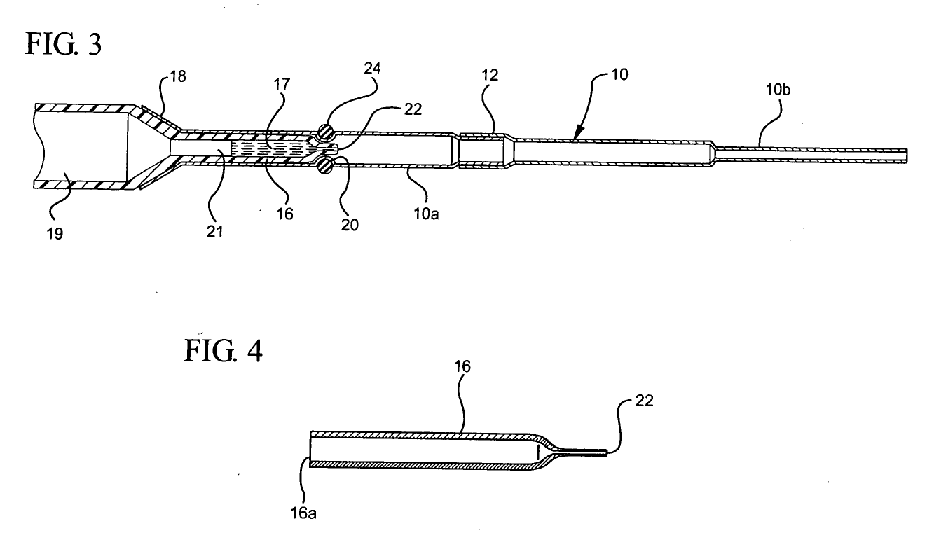

As seen in the drawings, the hollow needle for dental procedures is referred to generally by the reference numeral 10 and constitutes two parts, or sections 10a and 10b, which are connected together, for example by soldering, brazing or gluing. The connection of the two parts 10a and 10b is clearly seen at 12 in FIGS. 2 and 3 of the drawings. The working length of the needle can be increased by varying the length of part 10b prior to attachment to part 10a. Thus, the overall length of the needle can be selected by the dental professional in the order of 20 mm to 30 mm long depending upon the requirements for the particular procedure.

The back end of the needle, which is part 10a, has a larger diameter than the forward end, or part 10b. The back end of the needle is provided with a chamber 14 of a size to accommodate and house an open ended cartridge 16 for heated thermoplastic material, such as gutta perch, for filling a cavity of a tooth. The back end of the needle is also provided with a conical-shaped entranceway 18 to accommodate a similar shaped ram or plunger 19, as shown in FIG. 3.

As seen in FIG. 2, part 10a in the back end of the hollow needle is provided with a circumferential depression 20 in which an O-ring 24 is inserted, as shown in FIG. 3. The open-ended cartridge is provided with a nozzle 22 that is held in place by the O-ring 24 in depression 20. Thus, when the ram 19 in the syringe is pressed forward into the back end of the needle, as seen in FIG. 3 the thermoplastic material in the cartridge 16 is forced forward by the ram 21 and is squeezed through the nozzle 22 of the cartridge and through the forward end part 10b and into the cavity to be obturated. After the procedure is successfully completed the needle is discarded. At the same time the syringe, which continues to be used, remains clean and does not require extensive cleaning for re-use.

FIG. 4 shows the cartridge 16 with an open-end 16a and in the present arrangement the cartridge is heated to a selected temperature until the dental filling material therein becomes thermoplastic and the cartridge is then placed in the chamber 14. The needle is fabricated of a metal alloy, such as cusil to provide the needle with added strength and durability, or a thermo-conductive plastic. It should be noted that larger back end of the hollow needle that houses the cartridge additionally makes the needle more robust, while the front end is much smaller and is more malleable and bendable than the back end for maneuverability through the channels or openings of the tooth, and furthermore the needle can be increased in overall length, if required.

While there has been shown and described an embodiment of the present invention, it will be understood that one may make various changes in the form and details of the device illustrated and its operation without departing from the true spirit of the invention.

1) A two part needle for a syringe for injecting heated thermoplastic material in a dental cavity comprising a rear part of greater diameter than the front part, a chamber in the rear part, an open ended cartridge provided with a nozzle and having said heated thermoplastic material therein positioned in said chamber, and plunger means in said syringe for forcing said thermoplastic material out of said nozzle and through said front part of the needle and into said dental cavity.

2) The two part needle as claimed in claim 1 wherein the length of the front part can be selected from 20 mm to 30 mm prior to attachment to said rear port, and, at least some of the front part is of such s small diameter as to be bendable when in use.

3) A two part needle as claimed in claim 1 wherein said rear part has a circumferential external groove, an O ring in said groove whereby said chamber is defined therein.

4) A two part needle as claimed in claim 3 wherein said groove forms a narrow opening in said chamber, and said nozzle of said cartridge projects through said narrow opening.

5) A two-part needle as claimed in claim 1 wherein said first part is attached to said second part by soldering.

6) A two-part needle as claimed in claim 1 wherein said first part is attached to said second part by brazing.

7) A two-part needle as claimed in claim 1 wherein said first part is attached to said second part by gluing.

8) A needle for a syringe for injected heated thermoplastic material in a dental cavity comprising a rear tubular part provided with a funnel-shaped opening adjacent to said syringe, a front tubular part, said rear part having a diameter greater than said first part, said rear tubular part having a circumferential groove defining the end of said chamber remote from said funnel-shaped opening, an open-ended cartridge having said heated thermoplastic material therein positioned in said chamber, and plunger means in said syringe for forcing said thermoplastic material out of said cartridge and through said front part of the needle and into said dental cavity.

9) A needle as claimed in claim 8 wherein said thermoplastic material is gutta percha.

10) A two part needle for an endodontic syringe for injecting a heated thermoplastic material into a root canal cavity comprising said needle having a front and rear tubular parts that are connected together, a cartridge having said heated thermoplastic material therein, said rear tubular part being of such a size and shape to form a chamber having said cartridge for pressing said thermoplastic material out of said cartridge and through said front tubular part of the needle and into said root canal cavity.

11) A needle as claimed in claim 8 wherein said plunger means corresponds in configuration to said funnel shaped opening in said rear tubular part.

12) A two-part needle, as claimed in claim 10 wherein said thermoplastic material is gutta percha.

13) The two-part needle as claimed in claim 10 wherein said needle is fabricated of a metal alloy.

14) The two-part needle as claimed in claim 10 wherein said needle is fabricated of a thermo-conductive plastic.
